(19) United States
(12) Patent Application Publication
(10) Pub. No.: US 2010/0027495 A1
(43) Pub. Date: Feb. 4, 2010

(54) Method and Apparatus for Providing Acknowledgment Signaling

(75) Inventors: Xiangguang Che, Beijing (CN); Adele Gao, Beijing (CN)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/525,958

(22) PCT Filed: Feb. 5, 2008
(86) PCT No.: PCT/IB08/00251

§ 371 Date: Aug. 5, 2009

Related U.S. Application Data
(60) Provisional application No. 60/888,230, filed on Feb. 5, 2007.

(51) Int. Cl. H04W 72/04

(52) U.S. Cl. 370/329

(57) ABSTRACT

An approach is provided for designating a predetermined number of acknowledgment channels corresponding to transmission channels utilized by a plurality of user equipment. Each of the acknowledgement channels provides signaling to indicate success or failure of a transmission over a respective one of the transmission channels. The approach is also provided for generating a message to map the acknowledgement channels with the transmission channels.

### RELATED APPLICATIONS

This application claims the benefit of the earlier filing date under 35 U.S.C. §119(e) of U.S. Provisional Application Ser. No. 60/888,230 filed Feb. 5, 2007, entitled “Method and Apparatus for Providing Acknowledgement Signaling,” the entirety of which is incorporated by reference.

### BACKGROUND

Radio communication systems, such as a wireless data networks (e.g., Third Generation Partnership Project (3GPP) Long Term Evolution (LTE) systems, spread spectrum systems (such as Code Division Multiple Access (CDMA) networks), Time Division Multiple Access (TDMA) networks, etc.), provide users with the convenience of mobility along with a rich set of services and features. This convenience has spawned significant adoption by an ever growing number of consumers as an accepted mode of communication for business and personal uses. To promote greater adoption, the telecommunication industry, from manufacturers to service providers, has agreed at great expense and effort to develop standards for communication protocols that underlie the various services and features. One area of effort involves control signaling, notably acknowledgment signaling in response to successful or failure of data transmission. However, acknowledgement signaling can impose significant overhead if performed inefficiently, thereby reducing network performance.

### SOME EXEMPLARY EMBODIMENTS

Therefore, there is a need for an approach for providing efficient acknowledgment signaling.

According to one aspect of an embodiment of the invention, a method comprises determining designating a predetermined number of acknowledgment channels corresponding to transmission channels utilized by a plurality of user equipment. Each of the acknowledgement channels provides signaling to indicate success or failure of a transmission over a respective one of the transmission channels. The method also comprises generating a message to map the acknowledgement channels with the transmission channels.

According to another aspect of an embodiment of the invention, an apparatus comprises a logic configured to designate a predetermined number of acknowledgment channels corresponding to transmission channels utilized by a plurality of user equipment. The logic is further configured to generate a message to map the acknowledgement channels with the transmission channels.

According to another aspect of an embodiment of the invention, a method comprises receiving a message from a network element. The method also comprises the message specifying a mapping of acknowledgment channels to transmission channels. Each of the acknowledgement channels provides signaling to indicate success or failure of a transmission over a respective one of the transmission channels.

According to yet another aspect of an embodiment of the invention, an apparatus comprises a logic configured to receive a message from a network element, the message specifying a mapping of acknowledgment channels to transmission channels. Each of the acknowledgement channels provides signaling to indicate success or failure of a transmission over a respective one of the transmission channels.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The invention is illustrated by way of example, and not by way of limitation, in the figures of the accompanying drawings in which like reference numerals refer to similar elements and in which:

FIG. 1 is a diagram of a communication system capable of providing efficient acknowledgment signaling, according to an exemplary embodiment of the invention;

FIGS. 2A-2C are flowcharts of processes for providing efficient acknowledgment signaling, in accordance with various embodiments of the invention;

FIGS. 3A and 3B are diagrams showing exemplary systems providing schedule signaling timing/logic for frequency division duplex (FDD) and time division duplex (TDD), respectively;

FIGS. 4A and 4B are diagrams showing exemplary systems for FDD uplink (UL) acknowledgment/negative acknowledgment (ACK/NACK) timing and TDD UL ACK/NACK timing, respectively;

FIG. 5 is a diagram of exemplary TDD UL ACK/NACK channels in the downlink, according to an embodiment of the invention;

FIGS. 6A-6D are diagrams of communication systems having exemplary long-term evolution (LTE) architectures, in which the system of FIG. 1 can operate, according to various exemplary embodiments of the invention;

FIG. 7 is a diagram of hardware that can be used to implement an embodiment of the invention; and

FIG. 8 is a diagram of exemplary components of an LTE terminal configured to operate in the systems of FIGS. 6A-6D, according to an embodiment of the invention.

### DESCRIPTION OF PREFERRED EMBODIMENT

An apparatus, method, and software for providing acknowledgment signaling are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

Although the embodiments of the invention are discussed with respect to a communication network having a Third Generation Partnership Project (3GPP) Long Term Evolution (LTE) architecture, it is recognized by one of ordinary skill in the art that the embodiments of the inventions have applicability to any type of communication system and equivalent functional capabilities.

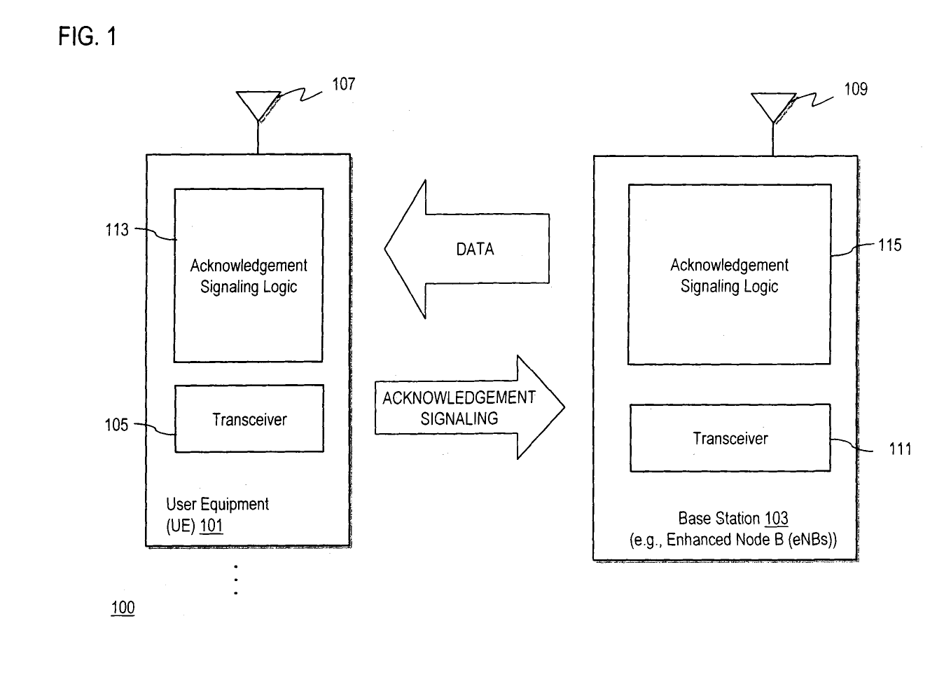

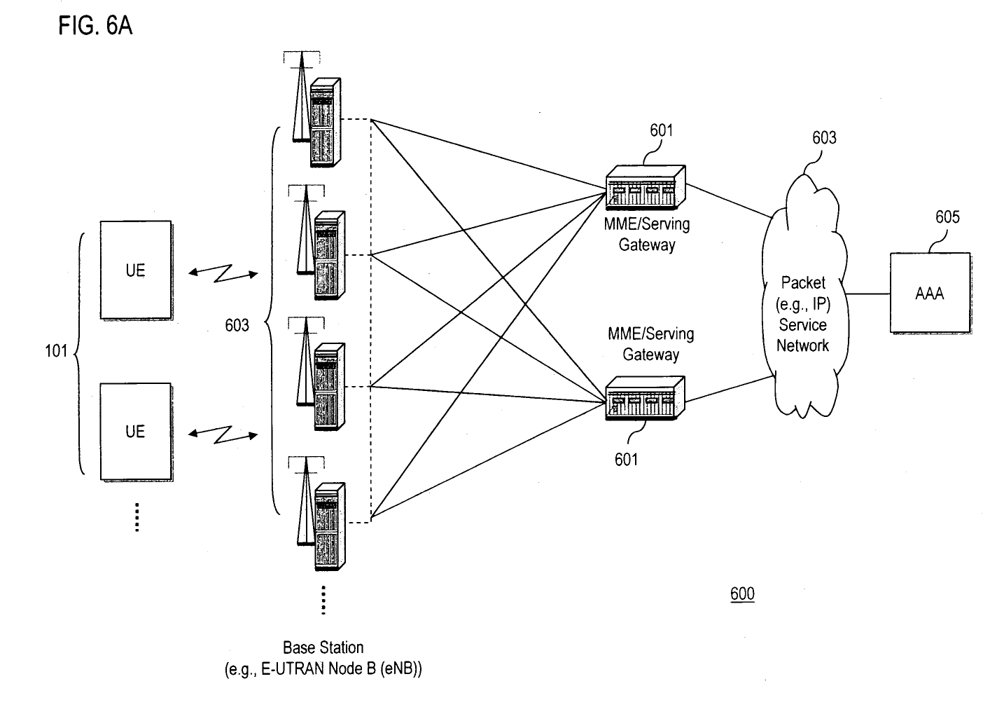

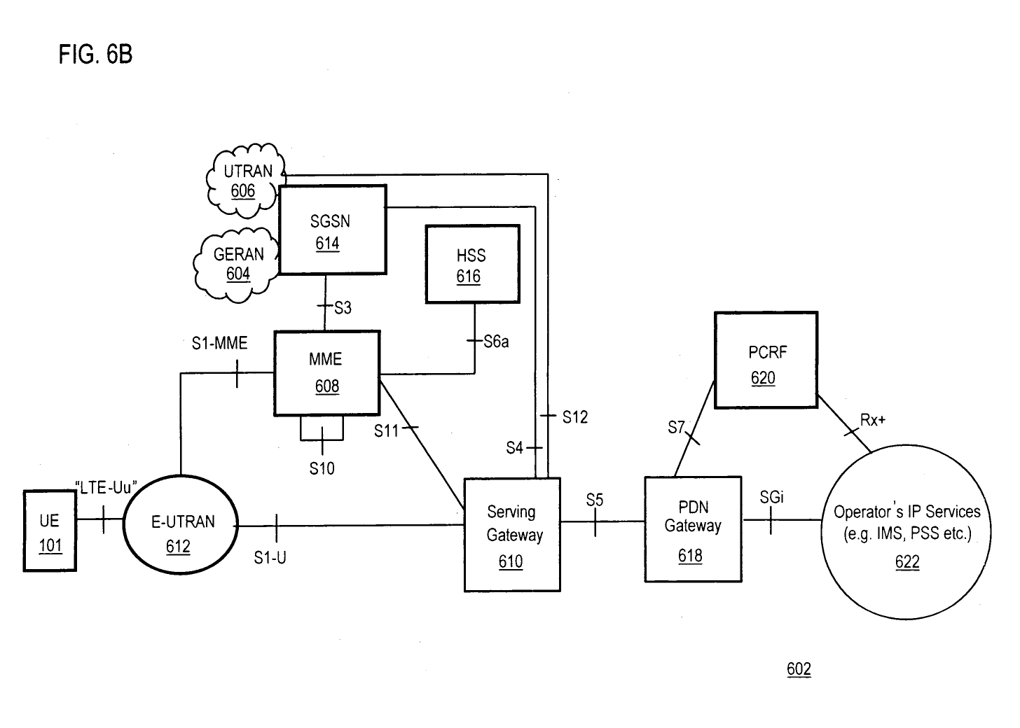

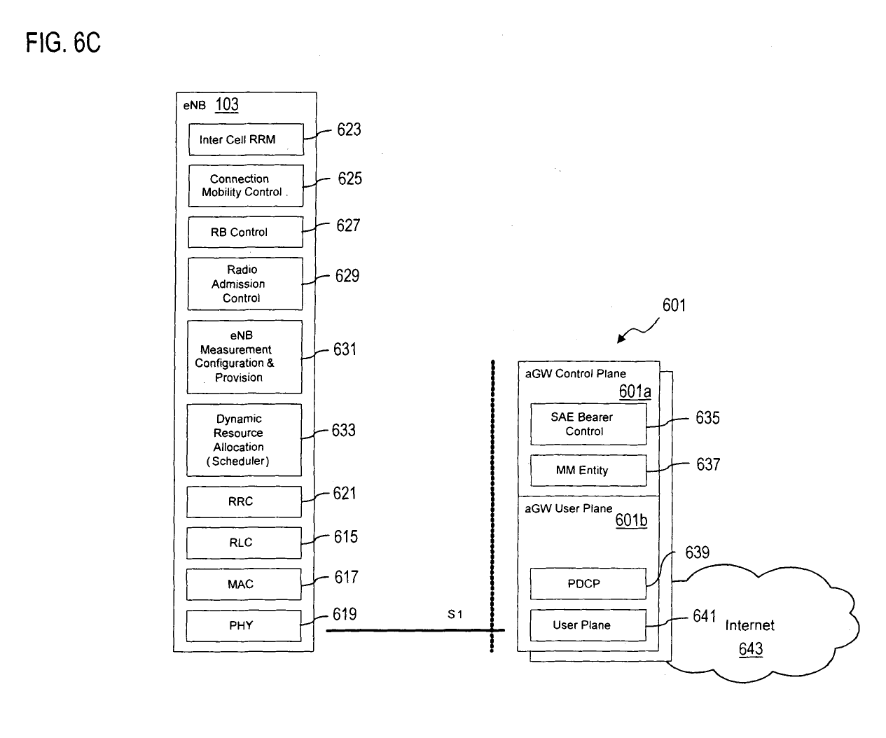

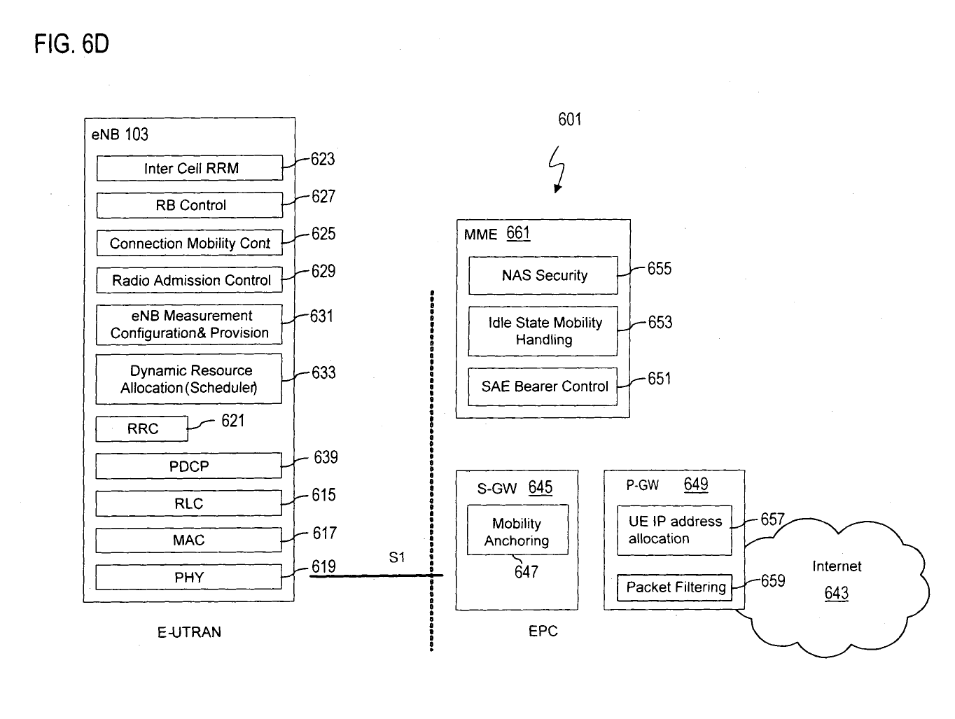

FIG. 1 is a diagram of a communication system capable of providing efficient acknowledgment signaling, according to an exemplary embodiment of the invention. As shown, a communication system 100 includes one or more user equipment (UEs) 101 communicating with a network equipment (or network element), such as a base station 103, which is part of an access network (e.g., WiMAX (Worldwide Interoperability for Microwave Access), 3GPP LTE (or E-UTRAN or 3.9G), etc.). By way of example, the communication system 100 is compliant with a 3GPP LTE architecture. Under the 3GPP LTE architecture (as shown in FIGS. 6A-6D), base station 103 is denoted as an enhanced Node B (eNB). The UE 101 can be any type of mobile stations, such as handsets, terminals, stations, units, devices, or any type of interface to the user (such as “wearable” circuitry, etc.).

The UE 101 includes a transceiver 105 and an antenna system 107 that couples to the transceiver 105 to receive or transmit signals from the base station 103. The antenna system 107 can include one or more antennas (of which only one is shown). Accordingly, the base station 103 can employ one or more antennas 109 for transmitting and receiving electromagnetic signals. As with the UE 101, the base station 103 employs a transceiver 111, which transmits information over a downlink (DL) to the UE 101.

The base station 103, in an exemplary embodiment, uses OFDM (Orthogonal Frequency Divisional Multiplexing) as a downlink (DL) transmission scheme and a single-carrier transmission (e.g., SC-FDMA (Single Carrier-Frequency Division Multiple Access) with cyclic prefix for the uplink (UL) transmission scheme. SC-FDMA can be realized also using DFT-S-OFDM principle, which is detailed in 3GGP TR 25.814, entitled “Physical Layer Aspects for Evolved UTRA,” v.1.5.0, May 2006 (which is incorporated herein by reference in its entirety). SC-FDMA, also referred to as Multi-User-SC-FDMA, allows multiple users to transmit simultaneously on different sub-bands.

In one embodiment, the communication system 100 employs a hybrid automatic repeat request (HARQ) technique to increase the air interference throughput and spectrum efficiency. Acknowledgment/negative acknowledgment (ACK/NACK) signaling is part of HARQ, for connecting a transmitter and a receiver, to enable the fast L1 (Layer 1 or Physical Layer) retransmission. As such, the UE 101 and the base station 103 include acknowledgement signaling logic 1113 and 115 to determine occurrence of transmission errors and to notify the source of the transmission of the errors, according to the HARQ mechanism. In one embodiment, the system 100 addresses the uplink (UL) ACK/NACK in downlink (DL) transmission, particularly for LTE TDD system, and thus, is provided with an efficient, lower-overhead and robust acknowledgement signaling approach.

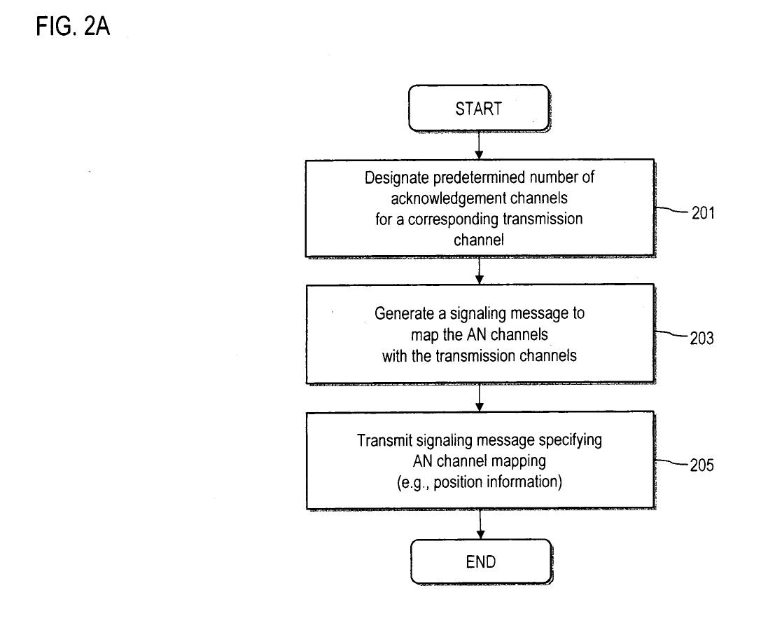

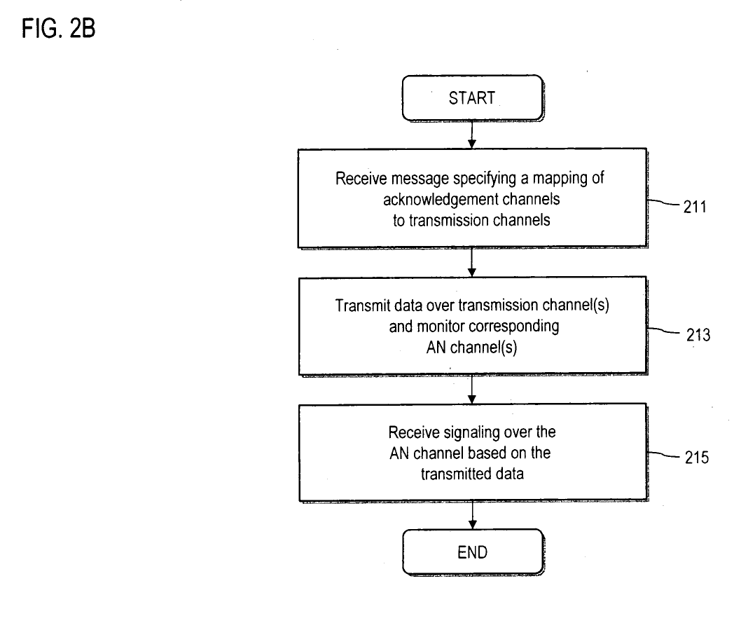

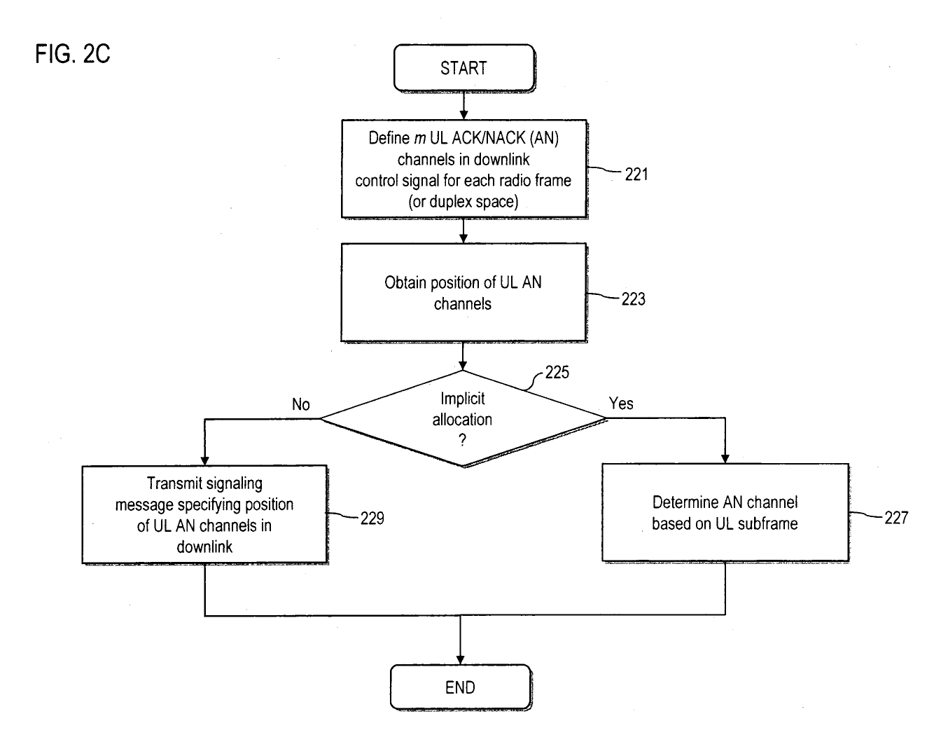

ACK/NACK signaling requires sufficient robustness to avoid neither retransmitting successfully received data packet nor transmitting new data packet before successful receipt the on-the-air old data packet. On the other hand, due to fast L1 retransmission, the frequency of ACK/NACK transmission to the designated receiver is very high (e.g., up to 1000 Hz), thus, transmission efficiency of ACK/NACK is desired to minimize the signaling overhead. The system 100, according to one embodiment, utilizes an acknowledgement signaling scheme that provides transmission efficiency, as detailed in FIGS. 2A-2C.

FIGS. 2A-2C are flowcharts of processes for providing efficient acknowledgment signaling, in accordance with various embodiments of the invention. In an exemplary embodiment, the acknowledgment signaling processes are explained with respect to the system of FIG. 1. As shown in FIG. 2A, in step 201, a predetermined number of acknowledgement/negative acknowledgement (AN) channels is designated for corresponding transmission channels. This assignment of AN channels can be performed by the base station 103 using acknowledgement signaling logic 115. By way of example, a certain number of UL ACK/NACK (AN) channels can be defined in L1 downlink control signaling per each radio frame or duplex space, wherein each UL ACK/NACK channel is corresponded with one UL subframe transmission of a UL share data channel. In step 203, a message is generated for indicating a mapping of the AN channels to the transmission channels. This message is then transmitted, as in step 205, to the UE 101.

On the receiver side (as shown in FIG. 2B), a control message is received by the UE 101, wherein the message specifies a mapping of AN channels to transmission channels, per step 211. In this example, the UE 101 has data to transmit, and thus, is assigned one of the transmission channels to carry the data. In step 213, the data is transmitted over the one or more transmission channels; the UE 101 then monitors the corresponding AN channels for acknowledgement signaling. Thereafter, the UE 101 receives, as in step 215, appropriate acknowledgement signaling in response to the data that was transmitted.

FIG. 2C shows an example of how the above processes are performed. Under this scenario, the system 100 (specifically, the BS 103, for example) defines, as in step 221, a number of UL AN channels in downlink control signal for each radio frame or a duplex space. For example, a number of UL ACK/NACK (AN) channels is predefined in a layer 1 (L1 or physical layer) downlink control signaling per each radio frame or duplex space. Each UL AN channel supports transmission of ACK/NACK bits for the corresponding one of the UL subframe.

The UE 101 obtains position of UL AN channels, per step 223. If the system 100 provides an implicit allocation for the AN channels (as determined in step 225), then, per step 227, the system 100 determines the AN channel based on the UL subframe. However, if the system 100 does not provide for implicit allocation, a signaling message is transmitted for conveying the position of the UL AN channels within the downlink, as in step 229.

In the context of a TDD system, the UE 101 can learn of its UL ACK/NACK bit(s) in the DL by a predefined implicit resource allocation or through use of minimal signaling overhead. Because there can be multiple UL and DL subframes in one TDD frame or one duplex space, and multiple scheduled UE in one UL subframe, the implicit allocation can be viewed in two parts. First, the time position of the ACK/NACK corresponding to the data transmission in the ith UL subframe; and second, multiplexing of ACK/NACKs for different UEs that transmitted UL data in the ith UL subframe.

A predefined mapping can be designated to indicate on which DL subframe to transmit the ACK for the data in the ith UL subframes. In an exemplary embodiment, the AN channels are mapped on a one-to-one (unique) basis to different UL subframes. Thus, as long as the UE 101 knows which UL subframe it is transmitting UL data packet (the UE 101 should know already before it gets ready to receive the ACK/NACK), the UE 101 will know uniquely which AN channel it should listen for. When UE 101 is transmitting data in multiple UL subframe, the UE 101 will then listen for multiple AN channels for its ACK/NACK bits.

To appreciate the above processes, it is instructive to examine other mechanisms for acknowledgment signaling.

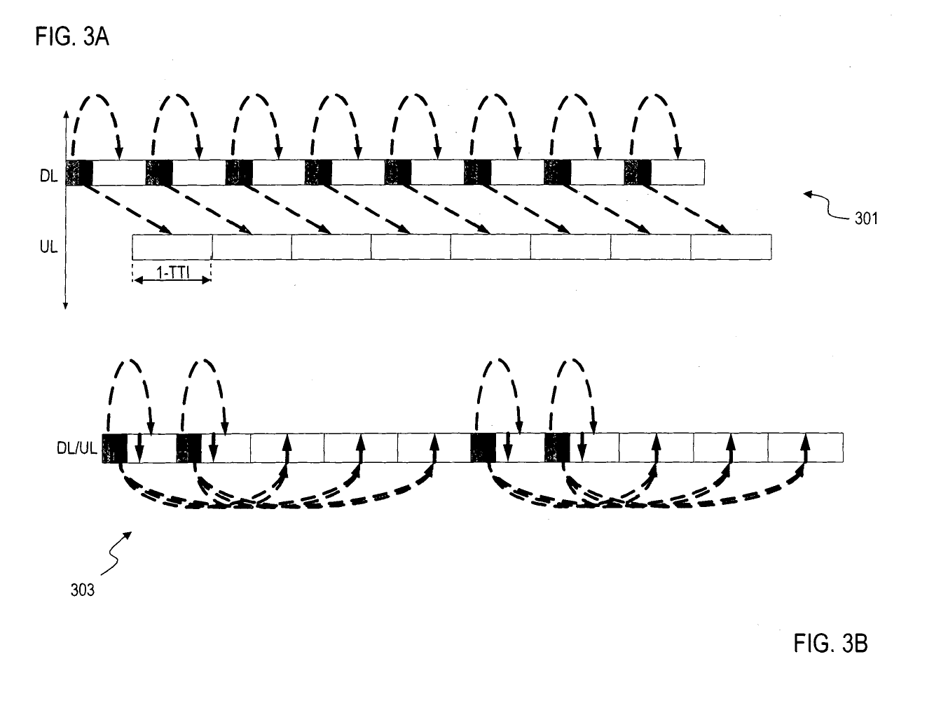

FIGS. 3A and 3B are diagrams showing exemplary systems providing schedule signaling timing/logic for frequency division duplex (FDD) and time division duplex (TDD), respectively. As shown, in one duplex space (5 ms in the example) DL scheduling signaling operates in similar manner for both FDD and TDD configurations 301 and 303. However, TDD operates differently in the UL—i.e., UL grant signaling entries in any of DL transmission time interval (TTI) may be allocated to any one of UL TTI to the targeted UE. In the FDD system, each UL grant signaling entry covers only one TTI, while the TDD system may provide UL grant signaling entries greater than one TTI, when the DL TTI is less than the UL TTI.

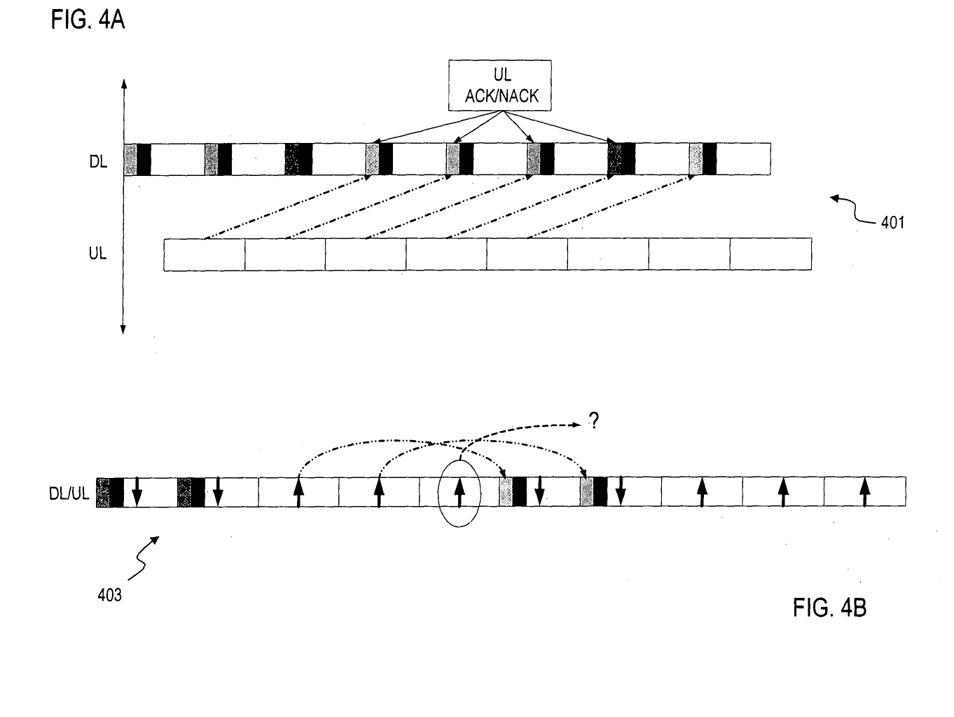

FIGS. 4A and 4B are diagrams showing exemplary systems for FDD uplink (UL) acknowledgment/negative acknowledgment (ACK/NACK) timing and TDD UL ACK/NACK timing, respectively. One conventional acknowledgement signaling mechanism involves the use of a user equipment identifier (ID). It is noted that attaching the user equipment ID as the destination identity to ACK/NACK bits is clearly inefficient because the ACK/NACK signal typically has only one or two bit per user equipment depending on the Multiple Input Multiple Output (MIMO) scheme that is employed, while the UE ID must be longer than that ACK/NACK bit, e.g. in LTE the UE-ID is assumed to be 16-bit signature. Therefore (because of the increase in overhead), indicating the destination without signaling the UE ID is desirable for efficient ACK/NACK transmission and improving the ACK/NACK bit error rate—i.e., robustness.

As seen in FIG. 4A, the FDD UL ACK/NACK timing of the FDD system 401 is rather straightforward. However, in the time division duplex (TDD) system 403, there is frequently more than one UL subframe transmission that requires multiple UL ACK/NACK in the DL transmission (as shown in FIG. 4B). Besides UE-ID, this raises additional time-domain dimension of the ACK/NACK signal's destination identity.

Also, other conventional approaches, in the case of TDD, can result in time-domain ambiguity when transmitting UL ACK/NACK in the DL subframe.

By contrast, the processes of FIGS. 2A-2C minimize the UL ACK/NACK bit (e.g., as low as 1 or 2 bits per UE (depending on MIMO deployment)) as well as maintain good robustness in the TDD system, particularly when the number of UL subframes is more than the number of DL subframes in a radio frame.

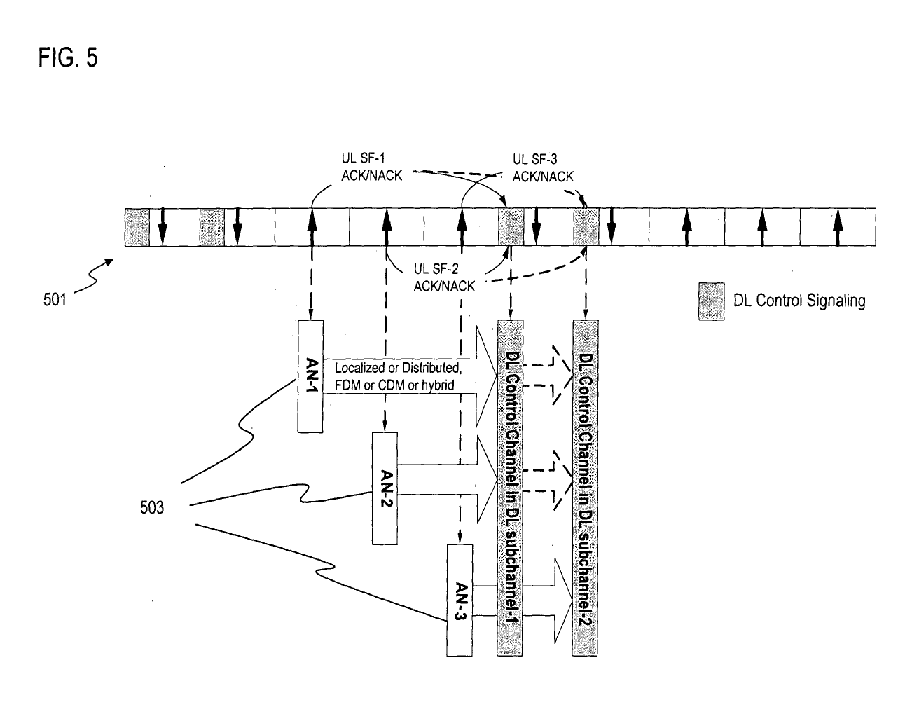

FIG. 5 is a diagram of exemplary TDD UL ACK/NACK channels in the downlink, according to an embodiment of the invention. In this example, the acknowledgment signaling approach, according to certain embodiments, addresses UL ACK/NACK transmission in a TDD system. Assuming there are m UL subframes in every radio frame 501, the base station 103 defines m UL AN channels 503 in downlink control signaling in that radio frame 501. These m UL AN channels 503 can be pre-allocated in one or a few of all or all downlink subframes; the position of these m UL AN channels 503 can be static, semi-static, or even dynamic depending on the overall LTE system requirement. The position of these m UL AN channels 503, in an exemplary embodiment, is signaled or broadcasted to all UE via radio resource control (RRC) signaling (static or semi-static), broadcast channel (BCH) signaling (static or semi-static or dynamic), or Cat0 signaling (static or semi-static or dynamic).

Each UL AN channel 503 can transmit UL ACK/NACK bits for the scheduled UE 101 in previous known subframe (TTI) by, for instance, various reliable and efficient known methods. Additionally, the timing requirement can be specified such that the needed processing time defines the smallest/shortest duration until an ACK/NACK can be transmitted. In the LTE example, this smallest/shortest duration can be a value (e.g., 1 ms) that satisfies the processing time and fits into numerology (for instance, ˜400 μs is acceptable for decoding the longest Turbo code block). As shown, it is observed that AN-3 can be mapped only into DL subframe-2, but not DL subframe-1 because processing time is insufficient.

Furthermore, the ACK-NACK in the same DL subframe can multiplexed using various standard techniques (e.g., frequency division multiplexing, code division multiplexing, or a hybrid scheme), and the UE 101 can determine the exact position within one AN channel by indexing the UE 101 within an AN channel. It is contemplated that other techniques can be employed as well. Under these approaches, a base station (e.g., base station 103), in subframe k, informs a terminal (e.g., UE-n) of the UL radio resources assignment using x-th L1/L2 control channel; and in subframe k+t, the base station transits UL AN to the UE-n using the x-th radio resources in AN channel (x-th sub-carrier set or x-th code).

The above acknowledgement signaling approach provides an efficient and robust technique that minimizes the required bits for UL ACK/NACK transmission in DL down to the least, i.e., 1 bit per user equipment. Also, the approach is flexible and consistent to support a variety of downlink/uplink configuration scenarios in a TDD system, and an UL AN channel structure for other non-dynamic scheduled user equipment. Further, the approach provides the flexibility of maintaining UL AN channel position in the TDD system, i.e. not necessarily to have UL AN channel in each of DL subframe or have only one UL AN channel in each of DL subframe. This may leave more room for a UL scheduler and UL transmission, and may potentially benefit the round trip delay in the TDD system.

FIGS. 6A-6D are diagrams of communication systems having exemplary LTE architectures, in which the system of FIG. 1A can operate, according to various exemplary embodiments of the invention. By way of example (shown in FIG. 1), the base station and the UE can communicate in system 600 using any access scheme, such as Time Division Multiple Access (TDMA), Code Division Multiple Access (CDMA), Wideband Code Division Multiple Access (WCDMA), Orthogonal Frequency Division Multiple Access (OFDMA) or Single Carrier Frequency Division Multiple Access (SC-FDMA) or a combination thereof. In an exemplary embodiment, both uplink and downlink can utilize WCDMA. In another exemplary embodiment, uplink utilizes SC-FDMA, while downlink utilizes OFDMA.

The MME (Mobile Management Entity)/Serving Gateways 601 are connected to the eNBs in a full or partial mesh configuration using tunneling over a packet transport network (e.g., Internet Protocol (IP) network) 603. Exemplary functions of the MME/Serving GW 601 include distribution of paging messages to the eNBs, IP header compression, termination of U-plane packets for paging reasons, and switching of U-plane for support of UE mobility. Since the GWs 601 serve as a gateway to external networks, e.g., the Internet or private networks 603, the GWs 601 include an Access, Authorization and Accounting system (AAA) 605 to securely determine the identity and privileges of a user and to track each user's activities. Namely, the MME Serving Gateway 601 is the key control-node for the LTE access-network and is responsible for idle mode UE tracking and paging procedure including retransmissions. Also, the MME 601 is involved in the bearer activation/deactivation process and is responsible for selecting the SGW (Serving Gateway) for a UE at the initial attach and at time of intra-LTE handover involving Core Network (CN) node relocation.

A more detailed description of the LTE interface is provided in 3GPP TR 25.813, entitled “E-UTRA and E-UTRAN: Radio Interface Protocol Aspects,” which is incorporated herein by reference in its entirety.

In FIG. 6B, a communication system 602 supports GERAN (GSM/EDGE radio access) 604, and UTRAN 606 based access networks, E-UTRAN 612 and non-3GPP (not shown) based access networks, and is more fully described in TR 23.882, which is incorporated herein by reference in its entirety. A key feature of this system is the separation of the network entity that performs control-plane functionality (MME 608) from the network entity that performs bearer-plane functionality (Serving Gateway 610) with a well defined open interface between them S11. Since E-UTRAN 612 provides higher bandwidths to enable new services as well as to improve existing ones, separation of MME 608 from Serving Gateway 610 implies that Serving Gateway 610 can be based on a platform optimized for signaling transactions. This scheme enables selection of more cost-effective platforms for, as well as independent scaling of, each of these two elements. Service providers can also select optimized topological locations of Serving Gateways 610 within the network independent of the locations of MMEs 608 in order to reduce optimized bandwidth latencies and avoid concentrated points of failure.

The basic architecture of the system 602 contains following network elements. As seen in FIG. 6B, the E-UTRAN (e.g., eNB) 612 interfaces with UE via LTE-Uu. The E-UTRAN 612 supports LTE air interface and includes functions for radio resource control (RRC) functionality corresponding to the control plane MME 608. The E-UTRAN 612 also performs a variety of functions including radio resource management, admission control, scheduling, enforcement of negotiated uplink (UL) QoS (Quality of Service), cell information broadcast, ciphering/deciphering of user, compression/decompression of downlink and uplink user plane packet headers and Packet Data Convergence Protocol (PDCP).

The MME 608, as a key control node, is responsible for managing mobility UE 101 identifies and security parameters and paging procedure including retransmissions. The MME 608 is involved in the bearer activation/deactivation process and is also responsible for choosing Serving Gateway 610 for the UE. MME 608 functions include Non Access Stratum (NAS) signaling and related security. MME 608 checks the authorization of the UE 101 to camp on the service provider's Public Land Mobile Network (PLMN) and enforces UE roaming restrictions. The MME 608 also provides the control plane function for mobility between LTE and 2G/3G access networks with the S3 interface terminating at the MME 608 from the SGSN (Serving GPRS Support Node) 614. The principles of PLMN selection in E-UTRA are based on the 3GPP PLMN selection principles. Cell selection can be required on transition from MME_DETACHED to EMM-IDLE or EMM-CONNECTED. The cell selection can be achieved when the UE NAS identifies a selected PLMN and equivalent PLMNs. The UE 101 searches the E-UTRA frequency bands and for each carrier frequency identifies the strongest cell. The UE 101 also reads cell system information broadcast to identify its PLMNs. Further, the UE 101 seeks to identify a suitable cell; if it is not able to identify a suitable cell, it seeks to identify an acceptable cell. When a suitable cell is found or if only an acceptable cell is found, the UE 101 camps on that cell and commences the cell reselection procedure. Cell selection identifies the cell that the UE 101 should camp on.

The SGSN 614 is responsible for the delivery of data packets from and to the mobile stations within its geographical service area. Its tasks include packet routing and transfer, mobility management, logical link management, and authentication and charging functions. The S6a interface enables transfer of subscription and authentication data for authenticating/authorizing user access to the evolved system (AAA interface) between MME 608 and HSS (Home Subscriber Server) 616. The S10 interface between MMEs 608 provides MME relocation and MME 608 to MME 608 information transfer. The Serving Gateway 610 is the node that terminates the interface towards the E-UTRAN 612 via S1-U.

The S1-U interface provides a per bearer user plane tunneling between the E-UTRAN 612 and Serving Gateway 610. It contains support for path switching during handover between eNBs 612. The S4 interface provides the user plane with related control and mobility support between SGSN 614 and the 3GPP Anchor function of Serving Gateway 610.

The S12 is an interface between UTRAN 606 and Serving Gateway 610. Packet Data Network (PDN) Gateway 618 provides connectivity to the UE 101 to external packet data networks by being the point of exit and entry of traffic for the UE 101. The PDN Gateway 618 performs policy enforcement, packet filtering for each user, charging support, lawful interception and packet screening. Another role of the PDN Gateway 618 is to act as the anchor for mobility between 3GPP and non-3GPP technologies such as WiMax and 3GPP2 (CDMA 1X and EvDO (Evolution Data Only)).

The S7 interface provides transfer of QoS policy and charging rules from PCRF (Policy and Charging Role Function) 620 to Policy and Charging Enforcement Function (PCEF) in the PDN Gateway 618. The SGi interface is the interface between the PDN Gateway and the operator's IP services including packet data network 622. Packet data network 622 may be an operator external public or private packet data network or an intra operator packet data network, e.g., for provision of IMS (IP Multimedia Subsystem) services. Rx+ is the interface between the PCRF and the packet data network 622.

As seen in FIG. 6C, the eNB utilizes an E-UTRA (Evolved Universal Terrestrial Radio Access) (user plane, e.g., RLC (Radio Link Control) 615, MAC (Media Access Control) 617, and PHY (Physical) 619, as well as a control plane (e.g., RRC 621)). The eNB 103 also includes the following functions: Inter Cell RRM (Radio Resource Management) 623, Connection Mobility Control 625, RB (Radio Bearer) Control 627, Radio Admission Control 629, eNB Measurement Configuration and Provision 631, and Dynamic Resource Allocation (Scheduler) 633.

The eNB 103 communicates with the aGW 601 (Access Gateway) via an S1 interface. The aGW 601 includes a User Plane 601a and a Control plane 601b. The control plane 601b provides the following components: SAE (System Architecture Evolution) Bearer Control 635 and MM (Mobile Management) Entity 637. The user plane 601b includes a PDCP (Packet Data Convergence Protocol) 639 and a user plane functions 641. It is noted that the functionality of the aGW 601 can also be provided by a combination of a serving gateway (SGW) and a packet data network (PDN) GW. The aGW 601 can also interface with a packet network, such as the Internet 643.

In an alternative embodiment, as shown in FIG. 6D, the PDCP (Packet Data Convergence Protocol) functionality can reside in the eNB rather than the GW 601. Other than this PDCP capability, the eNB functions of FIG. 6C are also provided in this architecture.

In the system of FIG. 6D, a functional split between E-UTRAN and EPC (Evolved Packet Core) is provided. In this example, radio protocol architecture of E-UTRAN is provided for the user plane and the control plane. A more detailed description of the architecture is provided in 3GPP TS 36.300.

The eNB interfaces via the S1 to the Serving Gateway 645, which includes a Mobility Anchoring function 647, and to a Packet Gateway (P-GW) 649, which provides an UE IP address allocation function 657 and Packet Filtering function 659. According to this architecture, the MME (Mobility Management Entity) 661 provides SAE (System Architecture Evolution) Bearer Control 651, Idle State Mobility Handling 653, NAS (Non-Access Stratum) Security 655.

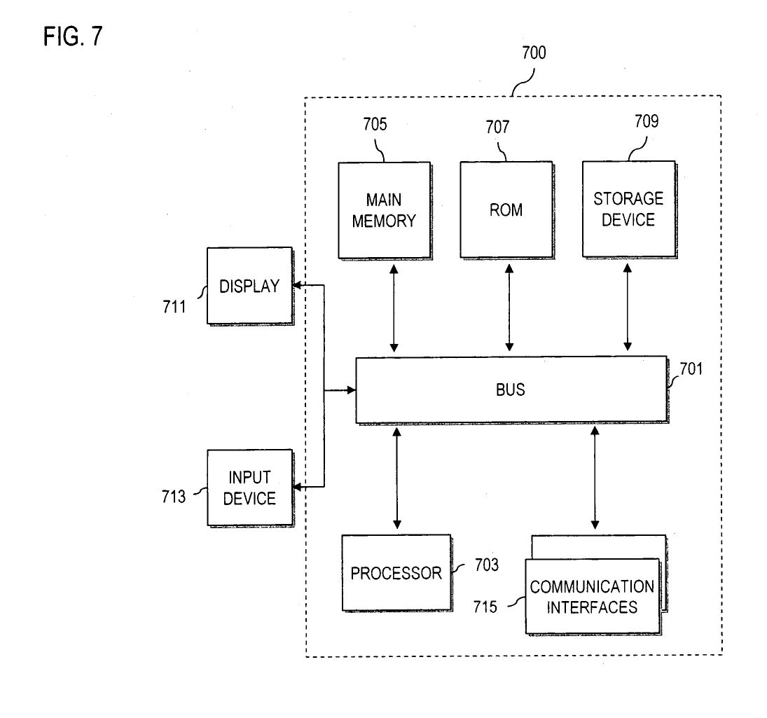

One of ordinary skill in the art would recognize that the processes for acknowledgement signaling may be implemented via software, hardware (e.g., general processor, Digital Signal Processing (DSP) chip, an Application Specific Integrated Circuit (ASIC), Field Programmable Gate Arrays (FPGAs), etc.), firmware, or a combination thereof. Such exemplary hardware for performing the described functions is detailed below with respect to FIG. 7.

FIG. 7 illustrates exemplary hardware upon which various embodiments of the invention can be implemented. A computing system 700 includes a bus 701 or other communication mechanism for communicating information and a processor 703 coupled to the bus 701 for processing information. The computing system 700 also includes main memory 705, such as a random access memory (RAM) or other dynamic storage device, coupled to the bus 701 for storing information and instructions to be executed by the processor 703. Main memory 705 can also be used for storing temporary variables or other intermediate information during execution of instructions by the processor 703. The computing system 700 may further include a read only memory (ROM) 707 or other static storage device coupled to the bus 701 for storing static information and instructions for the processor 703. A storage device 709, such as a magnetic disk or optical disk, is coupled to the bus 701 for persistently storing information and instructions.

The computing system 700 may be coupled via the bus 701 to a display 711, such as a liquid crystal display, or active matrix display, for displaying information to a user. An input device 713, such as a keyboard including alphanumeric and other keys, may be coupled to the bus 701 for communicating information and command selections to the processor 703. The input device 713 can include a cursor control, such as a mouse, a trackball, or cursor direction keys, for communicating direction information and command selections to the processor 703 and for controlling cursor movement on the display 711.

According to various embodiments of the invention, the processes described herein can be provided by the computing system 700 in response to the processor 703 executing an arrangement of instructions contained in main memory 705. Such instructions can be read into main memory 705 from another computer-readable medium, such as the storage device 709. Execution of the arrangement of instructions contained in main memory 705 causes the processor 703 to perform the process steps described herein. One or more processors in a multi-processing arrangement may also be employed to execute the instructions contained in main memory 705. In alternative embodiments, hard-wired circuitry may be used in place of or in combination with software instructions to implement the embodiment of the invention. In another example, reconfigurable hardware such as Field Programmable Gate Arrays (FPGAs) can be used, in which the functionality and connection topology of its logic gates are customizable at run-time, typically by programming memory look up tables. Thus, embodiments of the invention are not limited to any specific combination of hardware circuitry and software.

The computing system 700 also includes at least one communication interface 715 coupled to bus 701. The communication interface 715 provides a two-way data communication coupling to a network link (not shown). The communication interface 715 sends and receives electrical, electromagnetic, or optical signals that carry digital data streams representing various types of information. Further, the communication interface 715 can include peripheral interface devices, such as a Universal Serial Bus (USB) interface, a PCMCIA (Personal Computer Memory Card International Association) interface, etc.

The processor 703 may execute the transmitted code while being received and/or store the code in the storage device 709, or other non-volatile storage for later execution. In this manner, the computing system 700 may obtain application code in the form of a carrier wave.

The term “computer-readable medium” as used herein refers to any medium that participates in providing instructions to the processor 703 for execution. Such a medium may take many forms, including but not limited to non-volatile media, volatile media, and transmission media. Non-volatile media include, for example, optical or magnetic disks, such as the storage device 709. Volatile media include dynamic memory, such as main memory 705. Transmission media include coaxial cables, copper wire and fiber optics, including the wires that comprise the bus 701. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the invention may initially be borne on a magnetic disk of a remote computer. In such a scenario, the remote computer loads the instructions into main memory and sends the instructions over a telephone line using a modem or via a wireless link. A modem of a local system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

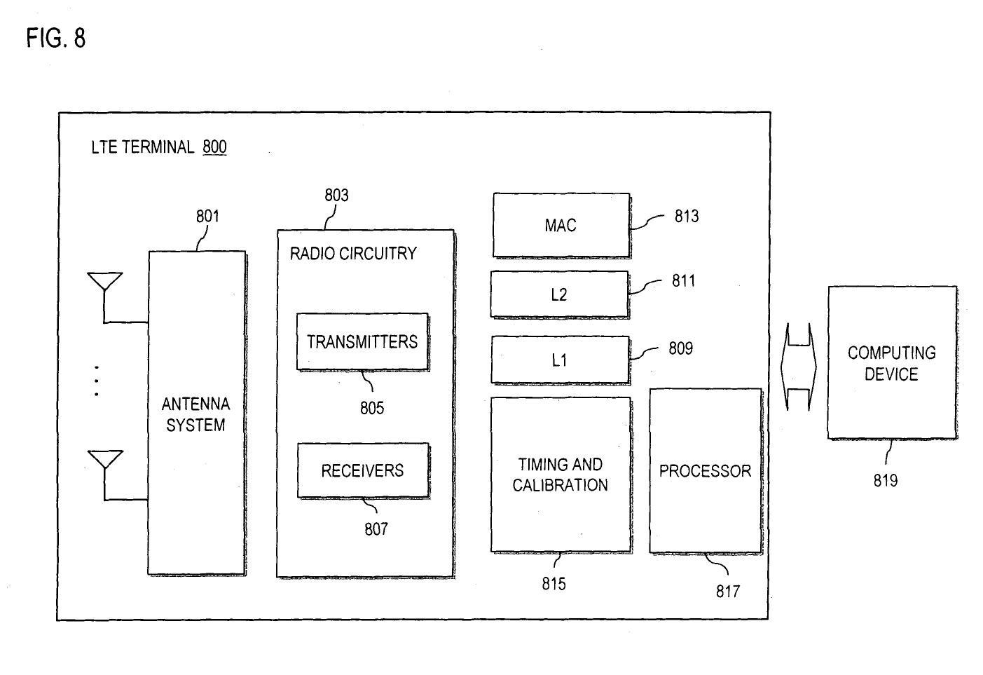

FIG. 8 is a diagram of exemplary components of an LTE terminal capable of operating in the systems of FIGS. 6A-6D, according to an embodiment of the invention. An LTE terminal 800 is configured to operate in a Multiple Input Multiple Output (MIMO) system. Consequently, an antenna system 801 provides for multiple antennas to receive and transmit signals. The antenna system 801 is coupled to radio circuitry 803, which includes multiple transmitters 805 and receivers 807. The radio circuitry encompasses all of the Radio Frequency (RF) circuitry as well as base-band processing circuitry. As shown, layer-1 (L1) and layer-2 (L2) processing are provided by units 809 and 811, respectively. Optionally, layer-3 functions can be provided (not shown). Module 813 executes all MAC layer functions. A timing and calibration module 815 maintains proper timing by interfacing, for example, an external timing reference (not shown). Additionally, a processor 817 is included. Under this scenario, the LTE terminal 800 communicates with a computing device 819, which can be a personal computer, work station, a PDA, web appliance, cellular phone, etc.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1-34. (canceled)

35. A method comprising:
determining a predetermined number of downlink acknowledgment channels corresponding to uplink transmission channels utilized by a plurality of user equipments, wherein each of the downlink acknowledgement channels provides signaling to indicate success or failure of a transmission over a respective one of the uplink transmission channels; and
determining a position of the downlink acknowledgement channels at least in part based on a position of the uplink transmission channels within a transmission frame.

36. A method according to claim 35, wherein the position of the downlink acknowledgement channels is determined by applying a predetermined offset on the position of the uplink transmission channels within the transmission frame.

37. A method according to claim 35, wherein the position of the uplink transmission channels comprises a subframe index within the transmission frame.

38. A method according to claim 35, wherein the downlink acknowledgement channels in a downlink subframe are multiplexed using at least one of frequency division multiplexing and code division multiplexing.

39. A method according to claim 35, wherein one of the user equipments utilizes a plurality of the uplink transmission channels to transmit data, and the user equipment is configured to listen to the downlink acknowledgement channels corresponding to the uplink transmission channels that are utilized.

40. A method according to claim 35, further comprising:
transmitting acknowledgment receipt of data over one of the downlink acknowledgment channels according to a hybrid automatic repeat request scheme.

41. A method according to claim 35, further comprising:
receiving acknowledgment receipt of data over one of the downlink acknowledgment channels according to a hybrid automatic repeat request scheme.

42. A computer program product comprising a computer-readable medium bearing computer program code embodied therein for use with a computer, the computer program code comprising:
code for determining a predetermined a number of downlink acknowledgment channels corresponding to uplink transmission channels utilized by a plurality of user equipments, wherein each of the downlink acknowledgement channels provides signaling to indicate success or failure of a transmission over a respective one of the uplink transmission channels; and
code for determining a position of the downlink acknowledgement channels at least in part based on a position of the uplink transmission channels within a transmission frame.

43. A computer program product according to claim 42, wherein the position of the downlink acknowledgement channels is determined by applying a predetermined offset on the position of the uplink transmission channels within the transmission frame.

44. An apparatus comprising:
a module comprising logic configured to determine a predetermined number of downlink acknowledgment channels corresponding to uplink transmission channels utilized by a plurality of user equipments; and
a processor configured to determine a position of the downlink acknowledgement channels at least in part based on a position of the uplink transmission channels within a transmission frame.

45. An apparatus according to claim 44, wherein the position of the downlink acknowledgement channels is determined by applying a predetermined offset on the position of the uplink transmission channels within the transmission frame.

46. An apparatus according to claim 44, wherein the position of the uplink transmission channels comprises a subframe index within the transmission frame.

47. An apparatus according to claim 44, wherein the downlink acknowledgement channels in a downlink subframe are multiplexed using at least one of frequency division multiplexing and code division multiplexing.

48. An apparatus according to claim 44, further comprising:
a transmitter configured to transmit acknowledgment receipt of data over one of the downlink acknowledgment channels according to a hybrid automatic repeat request scheme.

49. An apparatus according to claim 44, further comprising:
a receiver configured to receive acknowledgment receipt of data over one of the downlink acknowledgment channels according to a hybrid automatic repeat request scheme.

50. An apparatus according to claim 44, wherein one of the user equipments utilizes a plurality of the uplink transmission channels to transmit data, and the user equipment is configured to listen to the downlink acknowledgement channels corresponding to the uplink transmission channels that are utilized.

51. An apparatus according to claim 48, wherein the transmitter is embedded in a base station.

52. An apparatus according to claim 49, wherein the receiver is embedded in a mobile station.

53. An apparatus according to claim 44, wherein the transmission frame is a frequency division duplex frame or a time division duplex frame, and the transmission frame is transmitted over a data network compliant with a long term evolution architecture.
